(19) United States
(12) Patent Application Publication
(10) Pub. No.: US 2001/0025316 A1
(43) Pub. Date: Sep. 27, 2001

(54) Data processing apparatus in a time-based billing video-on-demand system and method therefor

(76) Inventor: Ji Soo Oh, Seoul (KR)

Correspondence Address: Benjamin J. Hauptman, LOWE HAUPTMAN GILMAN & BERNER, LLP, Suite 310, 1700 Diagonal Road, Alexandria, VA, 22314, US

(21) Appl. No.: 09/814,212

(22) Filed: Mar. 22, 2001

(30) Foreign Application Priority Data
Mar. 22, 2000 (KR) 2000-14688

(51) Int. Cl. G06F 15/16

(52) U.S. Cl. 709/231; 709/227

(57) ABSTRACT

Diversified user interfacing environment is provided in a time-based billing VOD system. Also disclosed is a database apparatus for providing the diversified user interfacing environment. A data processing method for transmitting video movie data having a plurality of frames from a server of a video movie provider to a user terminal in response to a request of the user in a VOD (Video-On-Demand) system, comprises the steps of: (a) determining whether the user is an authorized member; (b) if the user is the authorized member, transmitting information for movie selection to the user terminal; (c) when the user selects a particular movie, transmitting data for a play screen on which the user can operate the frames of the movie remotely and recording the time at which the data for the play screen is transmitted as a login time; (d) setting a value of a frame counter that counts the number of the currently transmitted frame as an initial value; and (e) when the user selects one of buttons including a play button, a stop button, a rewind button and a fast forward button, performing the function corresponding to the selected button.

### FIELD OF THE INVENTION

The present invention relates to a VOD (Video-On-Demand) system; and, more particularly, to a data processing apparatus for providing an interface for more convenient and more diversified services to a client in a time-based billing VOD system and a method therefor.

### DESCRIPTION OF THE PRIOR ART

In a VOD (Video-On-Demand) system, such contents as image data that is requested by a client is transferred from a server system to the client, i.e., a terminal of the client, under an on-line or off-line communication environment.

Data processing of moving picture video information is recently becoming a popular topic. This popularity stems from the wide spreading, from home to offices, of personal computers of which compact disc(CD) drive device can provide inexpensive and excellent functions for recording massive information such as the moving picture video information. Most of all, moving picture expert group(MPEG) format that has been developed by associations such as MPEG is progressed to easily operate complete moving picture video on a narrow band channel. MPEG video data compression/decompression algorithm provides a function of reducing the amount of information to be processed for proper screen construction to a proper level in digital video information processing and enables the digital video data to be stored densely on a digital recording medium. Due to this merit, the digital video information can be manipulated more easily so as to secure more users and thus the users request new distribution mechanism of the video content other than the CDs or typical tape cassettes. This request is realized by development of peripheral technologies, particularly communication technology so as to introduce a new concept of VOD.

However, in development of the VOD system to date, data transmission/receiving scheme for improving transmission rate and solving communication obstacles is mainly studied but little effort has been made to provide more convenient and more diversified user interfacing environment.

### SUMMARY OF THE INVENTION

Therefore, it is an object of the present invention to provide more diversified user interfacing environment in a time-based billing VOD system.

It is another object of the present invention to provide a database apparatus for providing diversified user interfacing environment.

In accordance with an aspect of the present invention, there is provided a data processing method for transmitting video movie data having a plurality of frames from a server of a video movie provider to a user terminal in response to a request of the user in a VOD (Video-On-Demand) system, the method comprising the steps of: (a) determining whether the user is an authorized member; (b) if the user is determined to be the authorized member, transmitting information for movie selection to the user terminal; (c) when the user selects a particular movie, transmitting data for a play screen on which the user can operate the frames of the movie remotely and recording the time at which the data for the play screen is transmitted as a login time; (d) setting a value of a frame counter that counts the number of the currently transmitted frame as an initial value; and (e) when the user selects one of buttons including a play button, a stop button, a rewind button and a fast forward button, performing the function corresponding to the selected button.

At the step (e), when the play button is selected, transmitting the video movie data from the frame corresponding to the value of the frame counter and recording the time at which the play button is selected; when the play button is stopped, recording the frames that moved while the play button is selected; when the stop button is selected, stopping data transmission of the movie data; when the rewind button is selected, changing the value of the frame counter to a previous frame by the number as the user requests and recording the time at which the rewind button is selected and the frames that are moved; and, when the fast forward button is selected, changing the value of the frame counter to a post frame by the number as the user requests and recording the time at which the fast forward button is selected and the frames that are moved.

### BRIEF DESCRIPTION OF THE DRAWINGS

The above and other objects and features of the instant invention will become apparent from the following description of preferred embodiments taken in conjunction with the accompanying drawings, in which:

FIG. 1 is a schematic diagram of a time-based billing VOD system in accordance with the present invention;

FIG. 2a is a schematic diagram of a user authorization screen formed on the user terminal;

FIG. 2b is a schematic diagram of a new registration screen formed on the user terminal;

FIG. 2c is a schematic diagram of an application screen for screen capture formed on the user terminal;

FIG. 2d is a schematic diagram of a mailing screen formed on the user terminal;

FIG. 3a is a schematic diagram of a movie selection screen formed on the user terminal;

FIG. 3b is a schematic diagram of a tried movies screen for formed on the user terminal;

FIG. 3c is a schematic diagram of an announcement screen formed on the user terminal;

FIG. 4 is a schematic diagram of a play screen formed on the user terminal;

FIGS. 5 and 6a are a schematic diagram of an exit screen formed on the user terminal;

FIG. 6b is a schematic diagram of a rate announcement screen formed on the user terminal;

FIG. 6c is a schematic diagram of a screen selection screen formed on the user terminal; and

FIGS. 7a to 7c are schematic flow charts for a system of the present invention.

### PREFERRED EMBODIMENT OF THE INVENTION

A preferred embodiment of the present invention will now be set forth in detail with reference to the accompanying drawings.

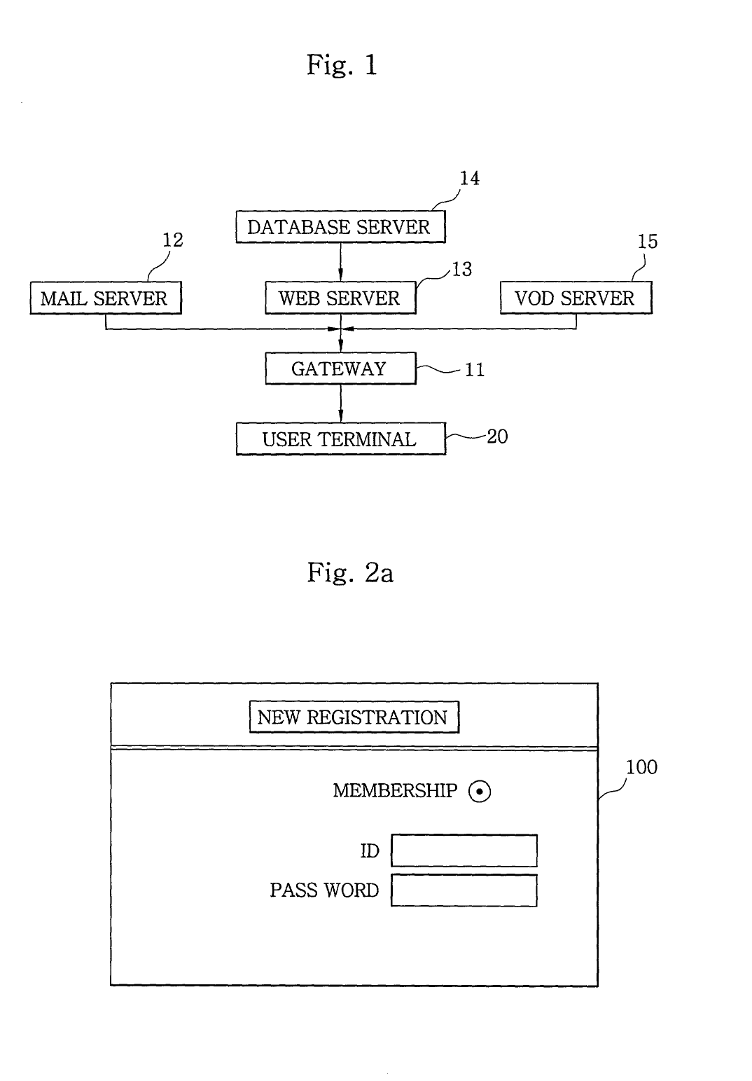

As shown in FIG. 1, a time-based billing VOD (Video-On-Demand) system of the present invention comprises a web server 13 for transmitting data in response to an external request and acting as a controller of the system, a database server 14 for storing and administrating user data and data required to provide services, a VOD server 15 for storing and administrating video movie data and data for preview of each movie, a mail server 12 for managing electronic mail between the client and a service provider. The database 14 in the system of the present invention includes a user information table having a number of fields such as name, address, telephone number, residence number, accounting settlement, ID, password and the like. Also, the database 14 in the system of the present invention includes a movie table having a number of fields such as title, genre, country, director, leading actor/actress, film company, year, the number of frames, rate, user score and the like, and a database table having diversified information for user's movie show, such as login time, date, button operation history of buttons of the user, e.g., play, rewind, fast forward, step-view and the like.

The servers 12, 13, 14, 15 are connected to each other in communication environment. The servers are connected to the Internet network or a service local network to which a user terminal 20 is connected via a gateway 11. The communication environment can be a LAN, the Internet environment or other well-known techniques. For example, it is desirable to keep a transmission rate higher than 1 Mbps that is minimum rate required for continuous transmission of a moving picture in the MPEG format.

In such a system, a time-based billing video movie service is provided as follows.

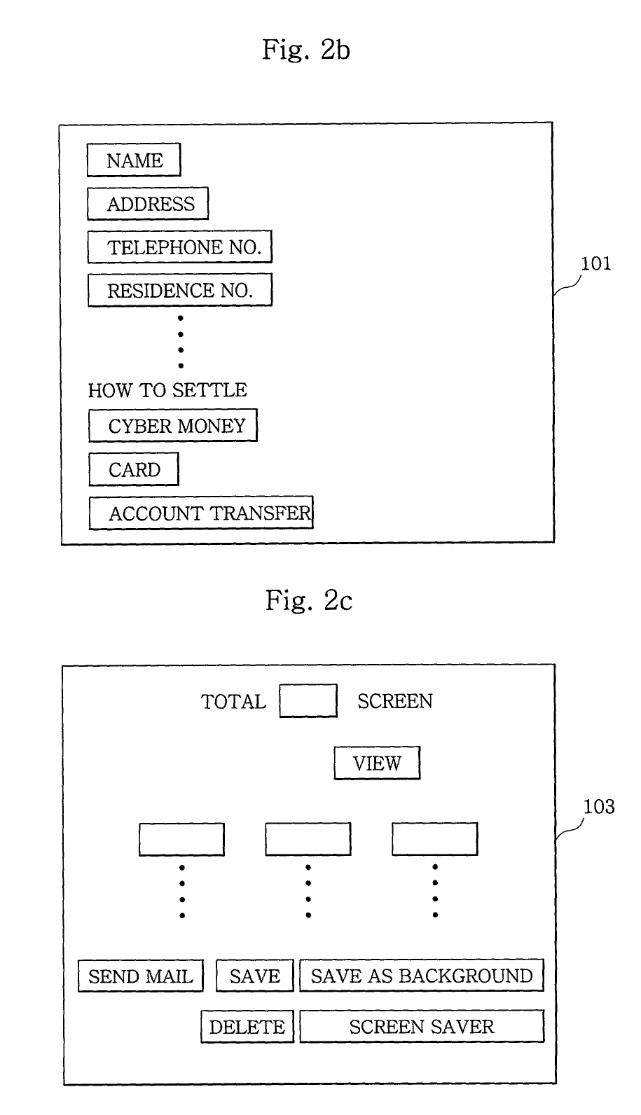

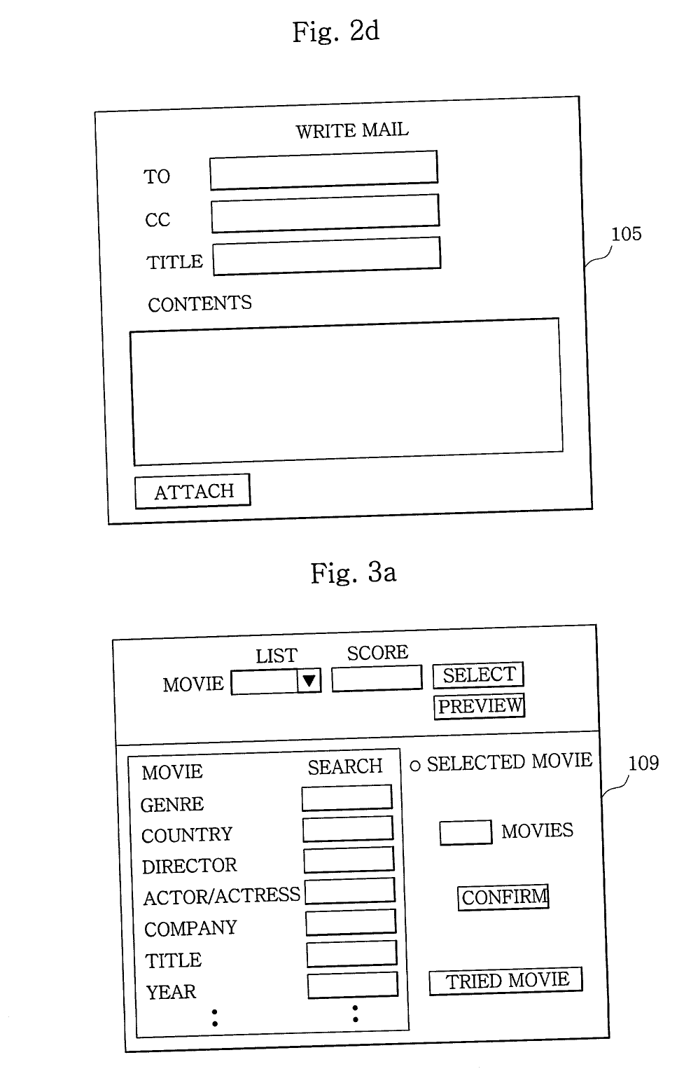

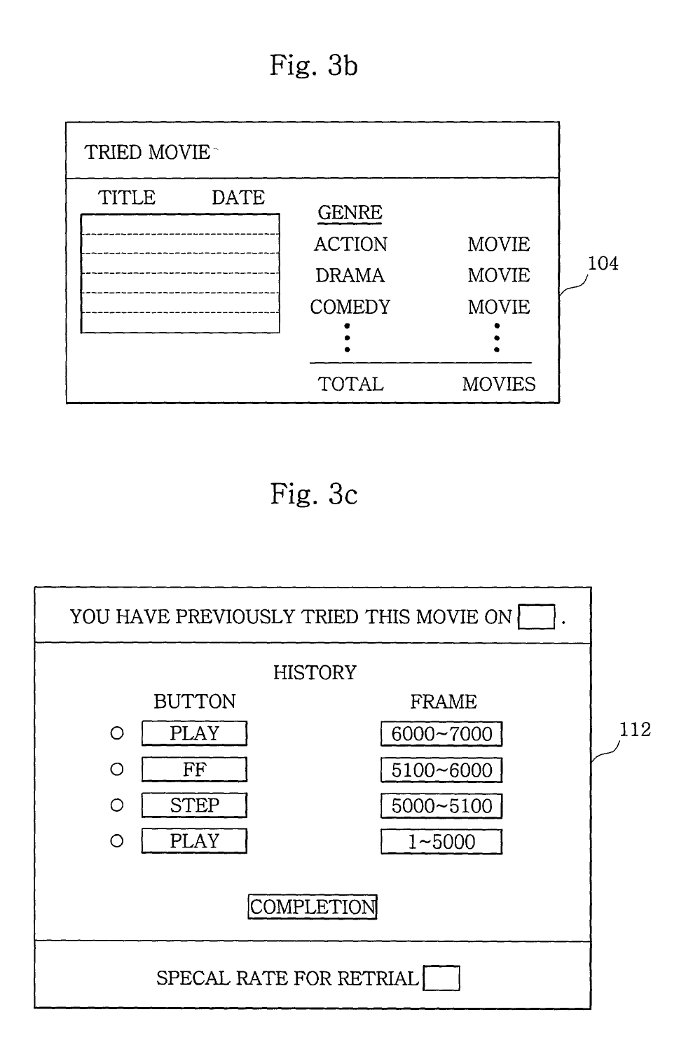

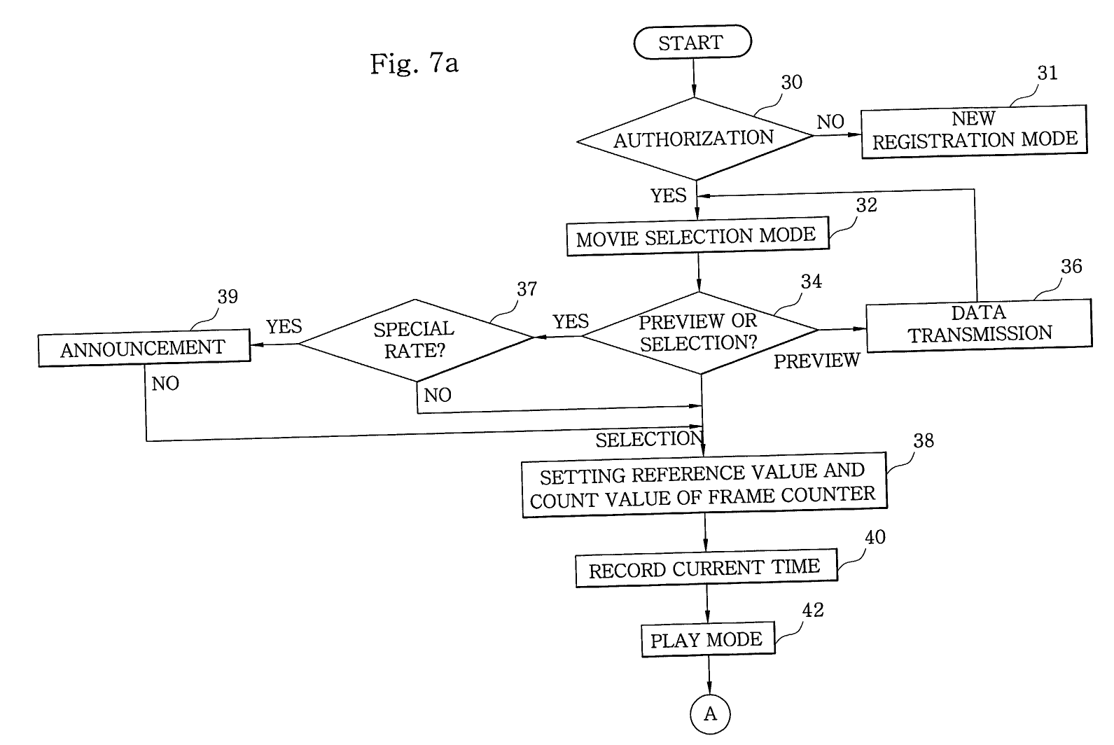

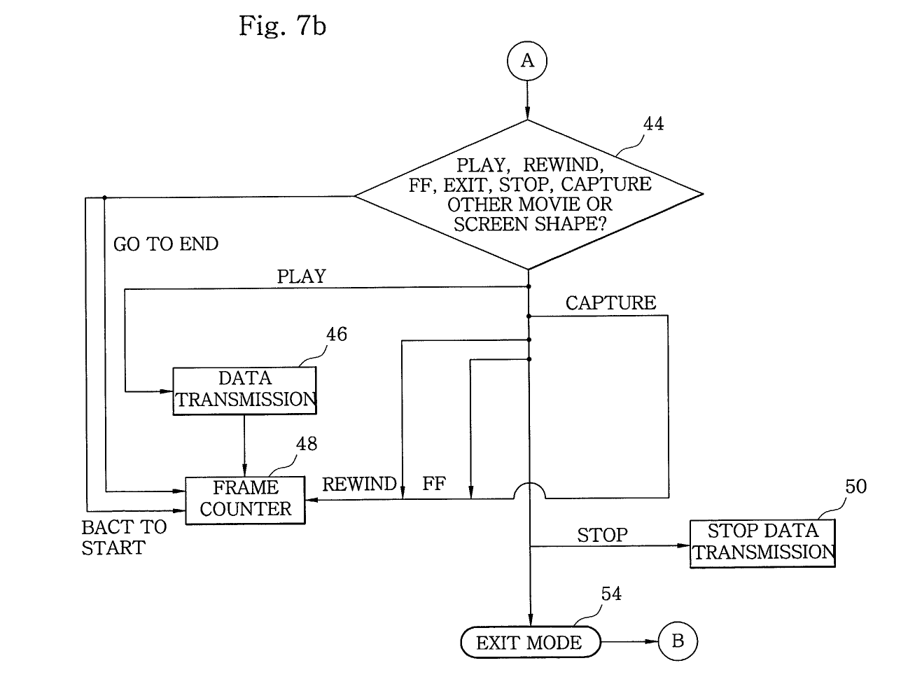

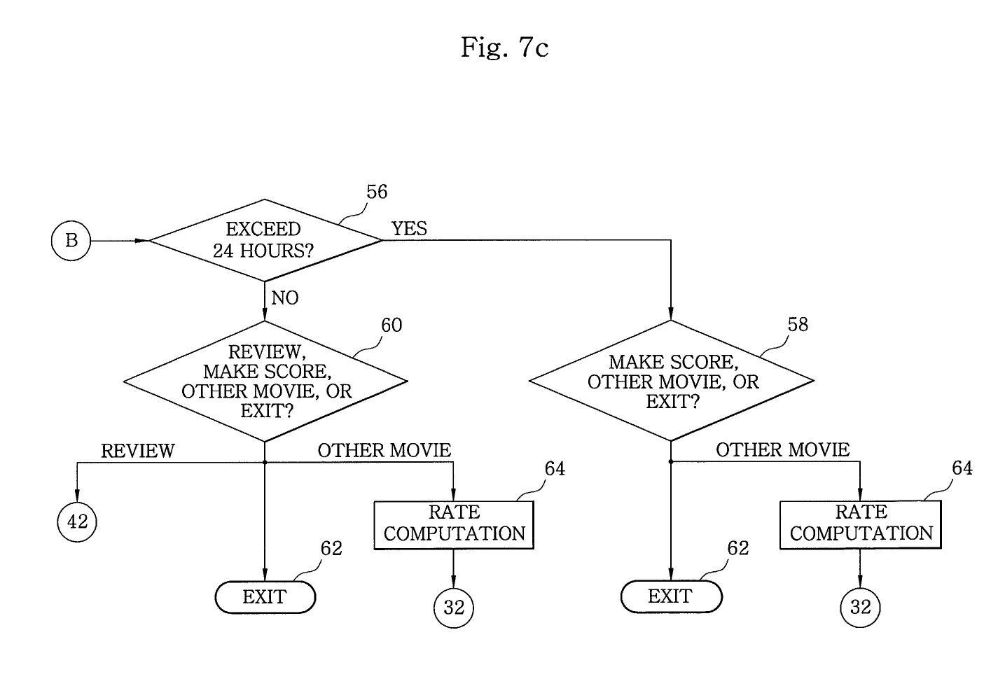

As shown in FIG. 7a, when a client makes an access to the system of the movie provider to order a video movie, user authorization procedure is firstly performed. As shown in FIG. 2a, a user authorization screen 100 is displayed, and the ID and the password are requested. It is desirable to transfer data for constructing the screen 100 from the web server 13 to the user terminal 20. And this data can be stored at an external storage of the user terminal 20 and requested by the web server 13. When the user enters the ID and the password, data for the entered ID and password is transmitted to the web server 13. The web server 13 transfers the ID information to the database server 14 to determine whether the entered ID exists, and receives the corresponding password to compare it with the entered password to determine whether the two passwords match. If the entered ID does not exist nor the two passwords do not match, the web server 13 notifies that to the user terminal 20. If the entered ID exist and the passwords match, as shown in FIG. 3a, the web server 13 transmits data for constructing a movie selection screen on which the authorized client can select a video movie or transmits to the terminal 20 a signal to request to load data that pre-stored at the user terminal 20 on a processor of the terminal 20.

If the client is determined as an unauthorized user at the user authorization step, when the client presses a new registration button as shown in FIG. 2a to newly register as a member, the web server 13 receives a signal corresponding to the pressed button and transmits data for constructing the new registration screen 101 to the user terminal 20 or transmits to the terminal 20 a signal to request to load data pre-stored at the user terminal 20 on a processor of the terminal 20. The client enters the ID, the password, personal information and accounting settlement on the new registration screen 101. As the accounting settlement for paying for video movie service, one of typical methods such as cyber money, electronic cash, credit card and account transfer can be selected. For example, it is desirable to bill the bill directly after movie selection if the cyber money or electronic cash is used and to record the bill at the database server 14 directly after movie selection and bill the bill in unit of month if the credit card or account transfer performed is used.

When the user's registration information is completely written and a completion key or an enter key is pressed, a corresponding signal is transferred to the web server 13 that registers the user's registration information at the database server 14 and transmits data for the user authorization screen to the user terminal 20 again.

Upon completion of the user authorization step 30, as shown in FIG. 3a, the movie selection screen 109 is constructed and movie selection mode is started (see step 32 in FIG. 7a). On the movie selection screen 109, the user can be provided with diversified information. Firstly, as shown in FIG. 3a, when the user clicks an arrow of a list combobox, the user can find a list of video movies by strolling the list. When the user selects a particular movie, the score of the selected movie is displayed, which is an average of scores given by the users who tried the selected movie among the registered users. It is desirable to grade the movie with a step of 0.5 from −5 to 5. Furthermore, it is desirable to provide it along with supplementary information for the selected movie such as the director, the leading actor/actress, running time and the number of times that the movie has been served. The web server 13 obtains the list of the movies, the score, the supplementary information from the database server 14. In the Internet environment, a list of about 10 movies, the scores and the supplementary information are transferred to the user terminal 20 along with the data for constructing the screen. It is desirable that, whenever the user requests other movie, the web server 13 reads related information from the database server 14 to transmit.

When the movie is selected, the user can see pre-view of the selected movie as well as the score and the supplementary information (see step 34 in FIG. 7a). That is, when a preview button in the movie selection screen is pressed, the web server 13 transmits data fro preview of the movie from the VOD server 15 to the user terminal 20 (see step 36 in FIG. 7a). Such video data is desirably transmitted in the MPEG format that is constructed by frames or other moving picture transmission format.

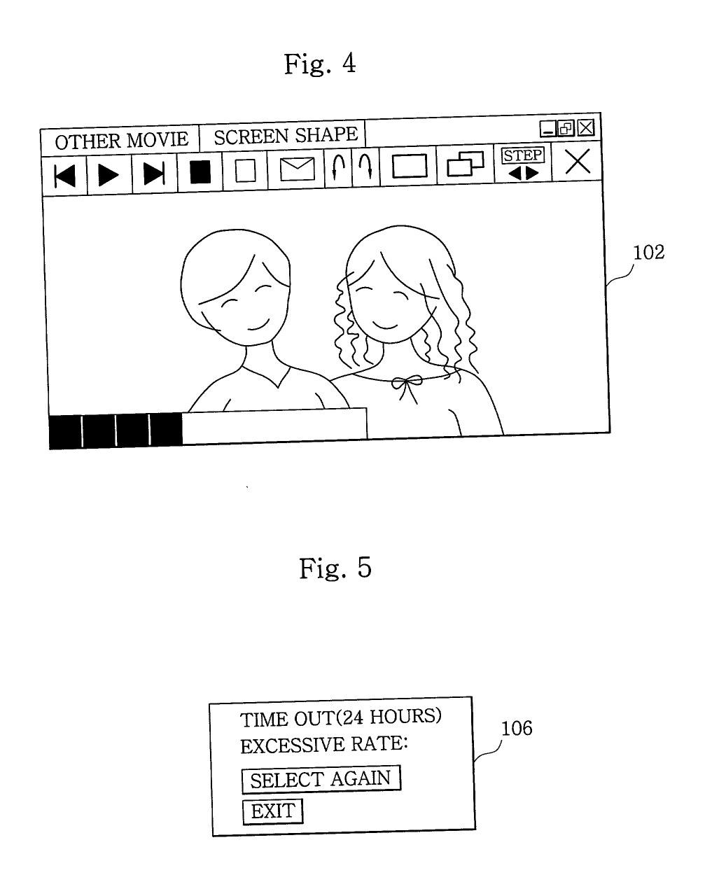

As shown in FIG. 4, the play screen is constructed for the preview. When a signal corresponding to the pressed preview button is transferred to the web server 13, the web server 13 transmits data for constructing the play screen 102 to the terminal 20 or transmits to the terminal 20 a signal to request to load screen constructing data pre-stored at the terminal 20 to the processor of the terminal 20. Then, the web server 13 transmits again video data to the VOD server 15. It will be explained for the playing screen 102 in detail later on.

After preview, the web server 13 transmits again data for constructing movie selection screen 109 to the terminal 20 or transmits to the terminal 20 a signal to request to load screen constructing data pre-stored at the terminal 20 to the processor of the terminal 20.

The movie selection screen 109 provides the user with information of the movies that the user have tried previously. That is, if the user clicks a tried movie button on the movie selection screen, as shown in FIG. 3b, a list of the tried movies is displayed along with date, the number of the movie for each genre and the total number of the tried movies. As described above, it is desirable that a list of about 10 movies is initially provided with the screen constructing data to the user terminal 20 and, when the user requests more lists, the web server 13 transfers other movies from the database server 14 to the user terminal 20.

When the user selects a movie and presses the completion button, movie code data corresponding to the selected movie is transferred to the web server 13. Then the web server 13 transfers the movie code data to the database server 14 to refer the field of the list of the tried movies in the user's account in order to determine whether the selected movie is firstly selected or tried previously.

If it is determined that the selected movie is firstly selected, the selected movie is added to the field of the list of the tried movies. Also, login time and date are added to the user's account.

If it is determined that the selected movie is tried previously, the web server 13 obtains data by referring to the history field of a last previous trial corresponding to the selected movie and then constructs the announcement screen 112 as shown in FIG. 3c on the user terminal 20. As shown in the drawing, a message that notifies that the user have previously tried that movie. It is desirable to provide the date when the user tried that movie previously. The history field of the last previous trial includes the buttons that the user clicked at the last previous trial and frame information of the video data moved by the clicked button. For example, the buttons are provided inversely in order of click sequence. The user can select one of the buttons on the announcement screen 112 and, when the screen for playing 102 is constructed and the play button is pressed, the movie can be played from the last frame corresponding to the button selected on the announcement screen 112. In other words, for example, if the top button is pressed on the announcement screen 112 as shown in FIG. 3c, the movie is played from the frame 7000 when the play button on the play screen 102. Therefore, the user can recognize the frame to which the user watches the movie.

Further, the field for the total number of the frames at the database server 14 is referred at this stage and special rate is applied if it is determined that the user have not yet watched the movie to the last frame by the history data of the last previous trial. Special rating method and rate can be applied in diversified ways. For example, it is desirable that ratio of the number of the frames that the user watches by using the play button to the total number of the frames is obtained and the discount rate is obtained by multiplying the ratio with the movie rate. That is,

(the number of the frames watched by the play button/the total number of the frames)×movie rate=special rate.

When the user presses the completion button on the announcement screen 112 or the movie selection screen 109, the web server 13 transmits data for constructing the play screen 102 as shown in FIG. 4 to the terminal 20 or transmits to the terminal 20 a signal to request to load the screen constructing data to the processor of the terminal 20.

At the same time, the web server 13 sets a count value of a frame counter for counting the transmitted frames to an initial value, e.g., 0. Here, the frame counter stores a frame number of the frame currently played on the play screen 102 as will be described later on. Also, the web server 13 reads current time as the login time and stores the read time at the database server 14. That is, the service time is started from the login time.

The play screen 102 acts as a player for watching the movie and provides diversified user interfaces. As shown in FIG. 4, the play screen 102 provides rewind, play, FF(fast forward), stop, capture, announcement, back to start, go to end, 1 fold ratio screen, 2 fold ratio screen, step, exit, other movie, and other screen shape buttons.

The rewind is for rewinding the screens as an ordinary VCR (video cassette recorder). That is, the rewind button is used to back to a previous frame. When the rewind button is pressed, a corresponding signal is transferred to the web server 13 and the web server 13 stops data transmission, reads the current frame value of the frame counter and changes the frame counter to a value obtained by subtracting a value requested by the user, e.g., time for which the user presses the rewind button, or a value computed based on movement of a time line bar at bottom of the screen. For managing the history function, when the rewind button is pressed, information for the pressed time and the number of the moved frames is stored at the database server 14.

When the play button is pressed, a corresponding signal is transferred to the web server 13, the web server 13 reads current time and obtains difference between the read time and the login time stored at the database server 14 to determine whether 24 hours expires. If 24 hours expires, it goes to exit mode 54 as shown in FIG. 7a. As shown in FIG. 5, the exit screen 106 is provided for the exit mode. If 24 hours do not expires, the web server 13 reads the value of the frame counter to request to the VOD server 15 the video data from the frame corresponding to the read counter value and transfers the video data to the user terminal 20. At this time, the value of the frame currently transmitted is computed from data index in the header of the transmitted data packet or the amount of the transmitted data and recorded at the frame counter. Further, the web server 13 compares the value of the frame counter with a final value whenever the frame counter changes or at a predetermined interval. When the frame counter reaches the final value, the web server 13 transfers data for constructing the exit screen 106 or the exit screen 108 to the user terminal 20, or transmits to the terminal 20 a signal to request to load screen constructing data pre-stored at the terminal 20 to the processor of the terminal 20. When the play button is pressed for the history function, information for the pressed time and the number of the moved frames is stored at the database server 14.

The FF is used to move forward fast as similar as the ordinary VCR. That is, the FF button is pressed to move to a post frame. When the FF button is pressed, a corresponding signal is transferred to the web server 13 and the web server 13 stops the data transmission, reads the current frame value of the frame counter, and changes the value of the frame counter by adding a value obtained based on time for which the user presses the FF button. At this time, while the user presses the FF button, the time line bar at the bottom of the screen moves to right. For the history function, the time for which information for the FF button is pressed and the number of the move frames is stored at the database server 14.

When the stop button is pressed, the web server 13 stops data transmission and records the value of the frame counter at the database server 14.

If the user selects the capture during data transmission, the web server 13 only records the value of the frame counter at the database server 14. Otherwise, as shown in FIG. 2c, the capture application screen 103 is constructed again. For this, the web server 13 transfers data for constructing the capture application screen 103 to the user terminal 20 or transmits to the terminal 20 a signal to request to load screen constructing data pre-stored at the terminal 20 to the processor of the user terminal 20.

After the capture application screen 103 is constructed, the total number of captured screens to date is notified and iconic images of the captured screens are displayed when the user requests to display them. For this, the web server 13 requests information for the captured screens to the database server 14 and requests corresponding frame data to the VOD server 15. Then, the web server 13 processes the frame data by a predetermined method to make the iconic frame data to provide to the user terminal 20. The iconic frame that selected by the user can be stored at the external storage of the user terminal 20, made as a background image or as a screen saver image, or mailed to another user terminal.

Particularly, when mailing is selected, a mailing screen 105 is displayed as shown in FIG. 2d. For this, the web server 13 transfers data for constructing the mailing screen 105 to the user terminal 20 or transmits to the terminal 20 a signal to request to load screen constructing data pre-stored at the terminal 20 to the processor of the user terminal 20.

When the user selects the announcement button, announcement from the movie provider to the client is displayed. For this, the web server 13 transmits data for announcement of the day or the week that received from the mail server 12 to the user terminal 20.

When the user selects the back to start button, the web server 13 stops data transmission and changes the current value of the frame counter to 0.

When the user selects the go to end button, the web server 13 stops data transmission and changes the current value of the frame counter to the last frame.

When the user selects the 1 fold ratio screen button, horizontal and vertical size of the screen is adjusted to have as same number of the pixels as that of the original video data.

When the user selects the 2 fold ratio screen button, horizontal and vertical size of the screen is expanded to have the number of the pixels 2 times that of the original video data.

When the user selects the step-view button, the screen is changed in unit of frame. For this, the web server 13 stops further data transmission and increases or decreases the value of the frame counter by one depending on clicking the arrow of the step-view icon. Further, the frame data corresponding to the value of the frame counter is transferred from the VOD server 15 to the user terminal 20. For the history function, when the step-view button is pressed, time for which the step-view button is pressed and information for the moved frames is stored at the database server 14.

When the exit button is pressed, the web server 13 reads information for the moved frames by the play, the rewind, the FF and the step-view buttons, of the movie that the user have watched, information for the final frame that the user watched, and the total number of the movie from the database server 14 to determine whether the user go through the movie to the end. If it is determined that the user have not gone through the movie to the end, screen for rate announcement 110 is constructed. On the other hand, if it is determined that the user have gone through the movie, the web server 13 transmits data for constructing the exit screen 106 or the exit screen 108 to the user terminal 20 or transmits to the terminal 20 a signal to request to load the screen constructing data pre-stored at the terminal 20 to the processor of the terminal 20.

The exit screen 106 or the exit screen 108 is displayed after the user presses the exit button on the play screen 102. The web server 13 confirms exit time and compares the exit time with the login time of the user at the database server 14. If time difference between the exit time and the login time is longer than 24 hours, the exit screen 106 is displayed and, if the time difference is shorter than 24 hours, the exit screen 108 is displayed.

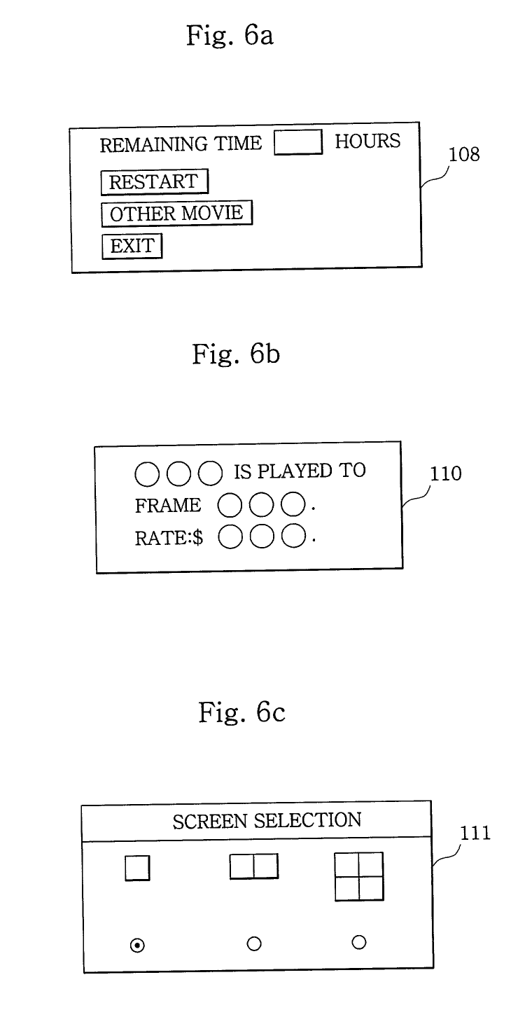

When the user selects the other movie button, the web server 13 stops data transmission and reads information for the moved frames by the play, the rewind, the FF and the step-view buttons, of the movie that the user have watched, information for the final frame that the user watched, and the total number of the movie from the database server 14 to determine whether the user go through the movie to the end. If it is determined that the user have not gone through the movie to the end, screen for rate announcement 110 as shown in FIG. 6b is constructed. At this time, information for watched frames can be read from the database server 14 to bill the rate for the watched frames. On the other hand, if it is determined that the user have gone through the movie, the rate for the user is computed and stored at the database server 14 and then the movie selection screen 109 is constructed to let the user select another movie.

When the screen shape button is pressed, screen select menu 111 is constructed as shown in FIG. 6c. Here, a number of screens are provided to the user.

As shown in FIG. 5, the exit screen 106 shows a message that notifies that one unit for service time is over at the exit time and the rate for excessive service of the movie. For this, the web server 13 transmits the time difference between the exit time and the login time and information for the rate computed by a predetermined processing method for converting the time difference to the rate along with the screen constructing data. Further, the user can the selects other movie button or the exit button.

When the user selects the other movie button, the web server 13 transmits data for constructing the movie selection screen to the user terminal 20 or transmits to the terminal 20 a signal to request to load the screen constructing data to the processor of the terminal 20 to the terminal 20. At the same time, the rate for the movie that the user have watched is recorded at the database server 14. After the user selects the exit button, connection between the web server 13 and the user is released.

On the other hand, if the time difference between the exit time and the login time is shorter than 24 hours, the exit screen 108 is constructed. For this, the web server 13 computes remaining time based on the obtained exit time and the login time at the database server 14 and transmits this remaining time to the user terminal 20 along with the screen constructing data or transmits to the terminal 20 a signal to load the screen constructing data stored at the terminal 20 to the processor of the terminal 20 to the terminal 20. Further, the use can selects review button, other movie button, or exit button. When the user presses the review button, the play screen 109 is generated again. For this, the web server 13 recognizing the signal corresponding to the review button transmits data for constructing the play screen 102 to the user terminal 20 or a signal to load the screen constructing data stored at the terminal 20 to the processor of the terminal 20 to the terminal 20. When the user selects the other movie button, the web server 13 transmits data for constructing the movie selection screen to the user terminal 20 or a signal to load the screen constructing data stored at the terminal 20 to the processor of the terminal 20 to the terminal 20. At the same time, the rate for the movie that the user have watched is recorded at the database server 14. After the user selects the exit button, the connection between the web server 13 and the user is released.

As described above, in the present invention, the user can enjoy on-line movie service in diversified user interface environment. Firstly, at the stage of movie selection, the preview is provided to the user so that the user can select the movie without confusing homonym movies. Further, the user can refer the leading actor/actress or the genre of the movie to select the movie even when the user does not know what the movie is.

Also, the database server of the invention stores the record for the buttons pressed by the user for a particular movie so as to prevent any unwanted selection of the movie that has been once tried and enable a special rate to be applied for the movie of which some part has been tried previously and provide the movie after the part already tried. Also, when the user wants to stop watching the movie and move to another movie, it is possible to bill the rate for only the watched part of the movie.

Further, according to the present invention, the frame that the user selects can be made as the screen saver and the background screen or attached to the electronic mail.

While the present invention has been shown and described with respect to the particular embodiments, it will be apparent to those skilled in the art that many changes and modifications may be made without departing from the spirit and scope of the invention as defined in the appended claims.

What is claimed is:

1. A data processing method for transmitting video movie data having a plurality of frames from a server of a video movie provider to a user terminal in response to a request of the user in a video-on-demand system, the method comprising the steps of:
(a) determining whether the user is an authorized member;
(b) if the user is determined to be the authorized member, transmitting information for movie selection to the user terminal;
(c) when the user selects a particular movie, transmitting data for a play screen on which the user can operate the frames of the movie remotely and recording the time at which the data for the play screen is transmitted as a login time;
(d) setting a value of a frame counter that counts the number of the currently transmitted frame as an initial value; and
(e) when the user selects one of buttons including a play button, a stop button, a rewind button and a fast forward button, performing the function corresponding to the selected button.

2. The data processing method as recited in claim 1, wherein, at said step (e), when the play button is selected, transmitting the video movie data from the frame corresponding to the value of the frame counter and recording the time at which the play button is selected; when the play button is stopped, recording the frames that moved while the play button is selected; when the stop button is selected, stopping data transmission of the movie data; when the rewind button is selected, changing the value of the frame counter to a previous frame by the number as the user requests and recording the time at which the rewind button is selected and the frames that are moved; and, when the fast forward button is selected, changing the value of the frame counter to a post frame by the number as the user requests and recording the time at which the fast forward button is selected and the frames that are caused to move.

3. The data processing method as recited in claim 2, wherein, at said step (b), if the user selects preview for a movie, preview data of the selected movie is transmitted to the user terminal.

4. The data processing method as recited in claim 3, wherein, at said step (e), if the user selects screen capture on the play screen, information for the frame at that time is recorded in the server.

5. The data processing method as recited in claim 4, further comprising the step of using the captured screen as a screen saver.

6. The data processing method as recited in claim 4, further comprising the step of using the captured screen as a background image.

7. The data processing method as recited in claim 4, further comprising the step of using the captured screen as an attached file for mailing.

8. The data processing method as recited in claim 1, wherein the server is provided with data concerning the movie evaluation score given by the users who have tried previously the movie and the score is provided to the user on the movie selection screen at said step (b).

9. The data processing method as recited in claim 1, wherein the database server has a list of movies that the user has tried previously, and said step (c) includes the step (c1) of comparing the selected movie with the movies in the list and then notifying the user of the fact that the user have tried the selected movie previously, if such is the case.

10. The data processing method as recited in claim 9, wherein the step (c) further includes the step (c2) of notifying the user of the buttons that are operated during just previous trial and the frames that are moved by the button operation in the sequence of button operation time and allowing the user to select one of the operated buttons after the step (c1), said step (d) stopped while said step (c2) is carried out.

11. The data processing method as recited in claim 10, wherein, at said step (c2), when it is determined by a determination process that the movie selected has not been completely watched by the user, a special rate fee is applied to the user.

12. The data processing method as recited in claim 11, wherein the determination process is adapted to determine the frames that are played by use of the play button as the frames that the user has watched.

13. The data processing method as recited in claim 1, wherein, the web server provides chatting function for enabling a plurality of the users to watch a movie and chat simultaneously.
